(19) United States
(12) Patent Application Publication
(10) Pub. No.: US 2015/0317741 A1
(43) Pub. Date: Nov. 5, 2015

(54) Online Claim System for Automated Insurance Claim Monitoring

(71) Applicant: STATE FARM MUTUAL AUTOMOBILE INSURANCE COMPANY, Bloomington, IL (US)

(72) Inventors: Stephanie Muxfeld, Bloomington, IL (US); Alexis Danielle Cates, Sherman, IL (US); John M. Dillard, Bloomington, IL (US); Robert John Fatima, Bloomington, IL (US); Richard Douglas Kitchen, Bloomington, IL (US); Shana K. Jevne, Normal, IL (US); Swati Pani, Bloomington, IL (US); Timothy Patrick Romer, Heyworth, IL (US); Surendra Karnatapu, Bloomington, IL (US); Amanda Surprenant, Woodstock, GA (US)

(73) Assignee: STATE FARM MUTUAL AUTOMOBILE INSURANCE COMPANY, Bloomington, IL (US)

(21) Appl. No.: 14/266,235

(22) Filed: Apr. 30, 2014

(51) Int. Cl. G06Q 40/08

(52) U.S. Cl. CPC G06Q 40/08

(57) ABSTRACT

An automated insurance claim monitoring system includes an OCS that receives data relating to a claim filed by a customer, automatically generates claim events based on the received data, and makes the claim events available to a device where the customer can view the events. The OCS may thus be used to provide a comprehensive review of all recent events relating to the processing of a claim, enabling a customer to use the device for obtaining the overall status of the claim as the claim is processed.

### FIELD OF THE INVENTION

The present disclosure generally relates to systems and methods for automatically informing a customer of a status of a filed insurance claim as the claim is being processed.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

When a customer files a claim on insured property, the insurance company that insures the property generally processes the claim by going through a number of stages. In a typical case, for example, processing a claim may include: (i) inspecting the property to identify damage, (ii) assessing the extent and/or cause of any identified property damage to determine if the damage is covered by the customer's insurance policy, (iii) estimating the cost to repair or replace the property for damage covered by the insurance policy, and (iv) issuing payment on the claim according to the estimated cost. Processing a claim also often includes facilitating property rental if the customer cannot use the insured property for a period of time (while being repaired or replaced, for example), handling subrogation issues (where the insurance company may pursue payment from a third party responsible for the damage, for example), determining financial obligations and/or payments (which may involve the insurance company, the customer, and/or a third party, and may account for insurance policy considerations such as a deductible), and assigning one or more representatives to facilitate completing any of the aforementioned claim processing activities. Insurance companies generally keep customers abreast of their claim status, if at all, via a person (such as an agent or other representative) who calls, mails, or emails the customer to inform the customer about a particular activity relating to the claim. Often times, however, a customer only learns about activities relating to the claim after contacting a representative to inquire about the claim or claim activities.

### SUMMARY

An online claim system (“OCS”) may automatically provide timely status updates about an insurance claim. The OCS may receive data relating to a claim filed by a customer, automatically generates claim events based on the received data, and make the claim events available to a device where the customer can view the events. The OCS may allow a customer to check on the status of a filed claim as the claim is being processed.

A method for automatically providing timely status updates about an insurance claim includes causing one or more processors to store, to memory, a first claim event relating to a first insurance claim filed by a first user. The first claim event may be a dataset including a first plurality of attribute values, where the first plurality of attribute values may include (i) a first claim identifier (ii) a first event identifier, (iii) a first timestamp, and (iv) a first event message regarding a status update for the first insurance claim. The method further includes receiving claim data at a network interface and causing one or more processors to determine, from the received claim data, a second plurality of attribute values. The second plurality of attribute values may include: a second claim identifier, a second event identifier, a second timestamp, and a second event message. The method further includes causing the one or more processors to (i) determine that the second claim identifier identifies the first insurance claim and (ii) determine, by comparing the second event identifier to the first event identifier, whether the second event identifier is associated with the first claim event. When the second event identifier is associated with the first claim event, the method may further include causing the one or more processors at the server to associate the second event message with the first claim event. When the second event identifier is not associated with the first claim event, the method may include causing the one or more processors at the server to: (i) generate a second claim event, the second claim event being a dataset including at least the second timestamp and the second event message, (ii) determine a chronological order based on the first timestamp associated with the first claim event and the second timestamp associated with the second claim event, and (iii) make available, to a device, the first event message and the second event message so that the device may display the first event message and the second event message according to the determined chronological order.

### BRIEF DESCRIPTION OF THE DRAWINGS

FIG. 1 illustrates an example automated insurance claim monitoring system.

FIG. 2 illustrates example GUIs for presenting information relating to claim events.

FIG. 3 illustrates an example method for generating a claim event in accordance with the described embodiments.

FIG. 4 illustrates an example method for informing a customer of recent claim events in accordance with the described embodiments.

FIG. 5 illustrates an example method for determining a device is associated with a customer in accordance with the described embodiments.

FIG. 6 illustrates a block diagram of an example automated insurance claim monitoring system.

FIG. 7 illustrates a data flow diagram of an example distributed OCS.

### DETAILED DESCRIPTION

An automated insurance claim monitoring system includes an OCS that receives data relating to a claim filed by a customer, automatically generates claim events based on the received data, and makes the claim events available to a device where the customer can view the events. The OCS may thus be used to provide a comprehensive review of all recent events relating to the processing of a claim, enabling a customer to use the device for obtaining the overall status of the claim as the claim is processed. The OCS benefits an insurance company by not only enabling the insurance company to provide personalized service to a particular customer (by way of the automatic comprehensive status updates made available for a claim filed by the customer), but by allowing the insurance company to dramatically increase the number of customers that can be served in such a manner with relatively minimal increase in cost to the insurance company. In other words, the OCS creates an economy of scale enabling an insurance company to automatically provide comprehensive status updates on thousands of claims filed by thousands of customers as the claims are processed. For example, in one implementation, the OCS may be utilized to generate and automatically provide roughly 200,000 claim events per day to customers around the world.

The OCS may be implemented to give customers a comprehensive review of the most recent activities relating to the processing of a filed insurance claim as the claim is being processed. While insurance companies sometimes communicate with customers about one or two particular activities at a time, this communication is often manual (i.e., initiated by an insurance company representative or the customer) and generally fails to give the customer a comprehensive snapshot of the claim processing status. Moreover, while certain techniques exist for updating a customer about activities potentially relating to an insurance claim (e.g., sending a bill to a customer when financial information has been processed, or notifying a customer when a car has been repaired and is ready for pickup), no technique exists for providing a customer with a comprehensive review of all recent activities related to the processing of a claim as the claim is being processed.

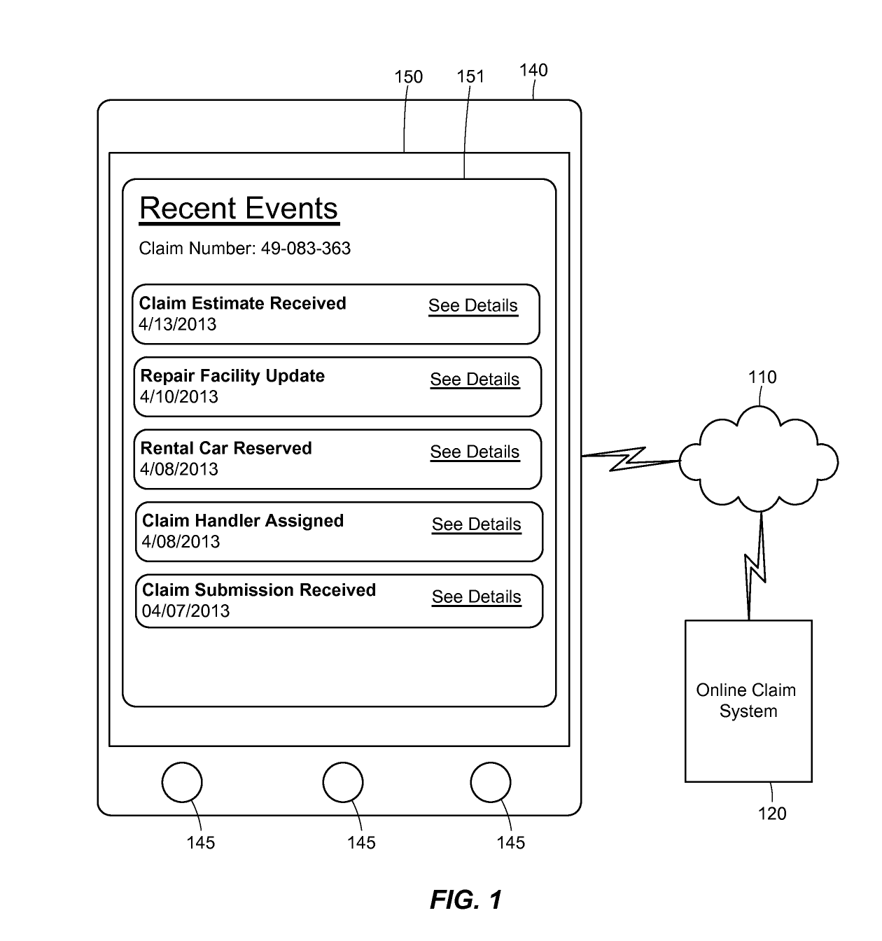

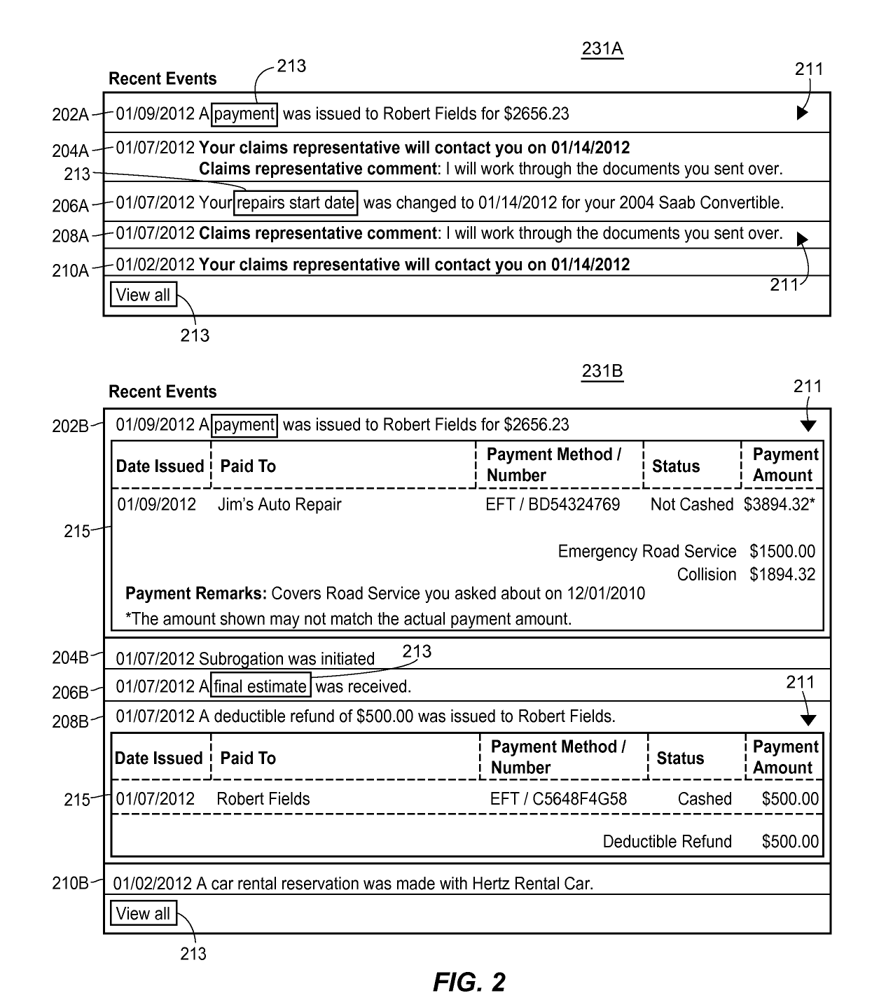

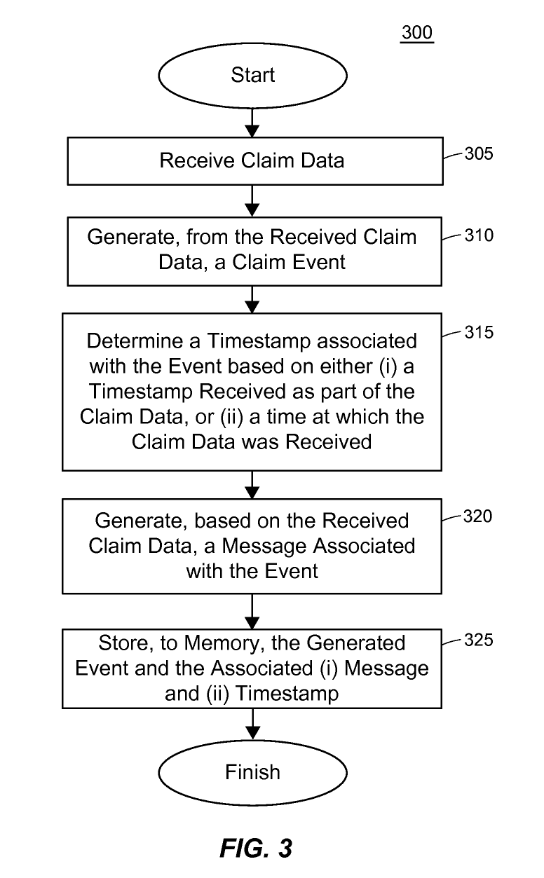

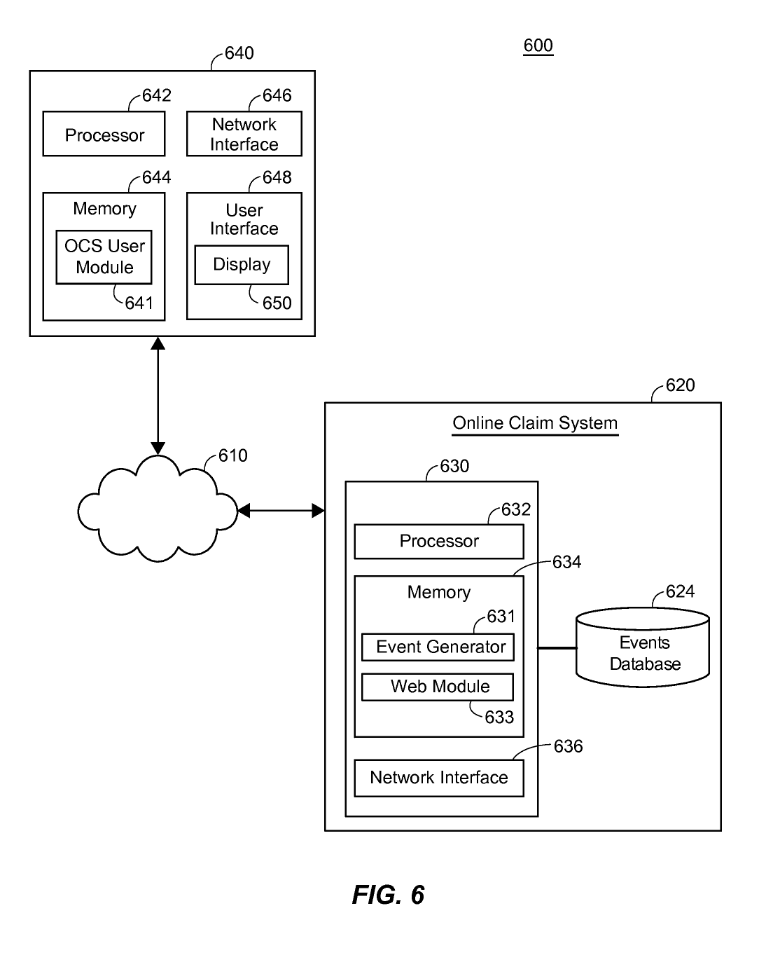

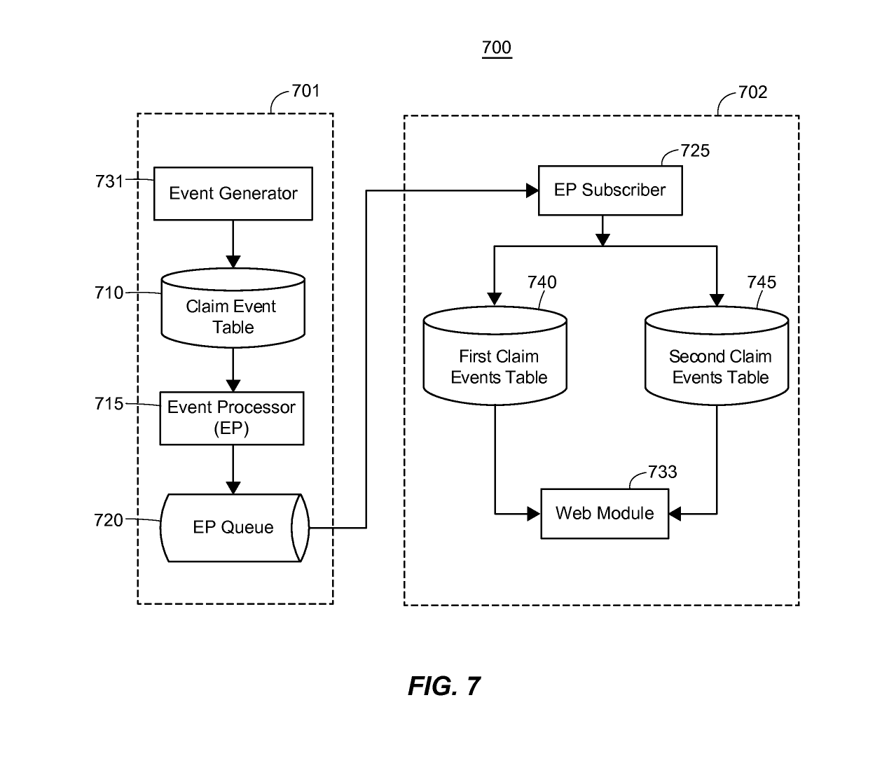

An OCS and associated techniques are discussed in detail below with reference to FIGS. 1-7. In particular, an overview and example Graphical User Interfaces (“GUIs”) are described with reference to FIGS. 1 and 2. Example methods that may be implemented at the OCS to generate claim events and make the claim events available to a client device are described with reference to FIGS. 3-5. An example automated insurance claim monitoring system that includes an OCS is described with reference to FIG. 6 and an example OCS is described with reference to FIG. 7.

### Overview

FIG. 1 illustrates an example automated insurance claim monitoring system 100. The automated insurance claim monitoring system 100 includes an OCS 120 (including, e.g., one or more servers) communicatively connected to a client device (“device”) 140 by way of a network 110, which may include any suitable number of wired and/or wireless communication links and nodes. The device 140 may be any type of computing device, such as a desktop computer, a laptop, smartphone, a tablet, etc.

In operation, as an insurance company handles a filed claim, the OCS 120 may be implemented to receive claim status updates and report claim events (representing the status updates) to the device 140 in real-time so that the device 140 may be used by a customer to monitor the claim as it is being processed.

For example, after a customer has filed a claim, the insurance company may begin processing the claim by storing (and potentially enabling third parties to store), at the OCS 120, data relating to the claim (“claim data”) representing, for example, customer information, financial information, insured property information, rental property information, etc. As the OCS 120 receives claim data, the OCS 120 generates and/or updates claim events representing status updates for the filed claim. The OCS 120 then transmits the claim events to the device 140 via the network 110.

The device 140, which includes a display 130 presenting a GUI 131, receives claim events and displays the claim events by way of the GUI 131. The customer may thus use the device 140 to view and interact with recent claim events relating to the claim. The customer may interact with the claim events by way of a user interface at the device 140 for receiving user input. For example, the display 130 may be a touchscreen that accepts touch input. The device 140 may also include hardware input components 126 (e.g., buttons or keys), a microphone for voice input, sensors for motion input, or any other interface for receiving user input. In any event, the user may interact with a recent event displayed by the GUI 131 to, for example, expand the claim event to view additional information. By giving the customer access to the claim events and associated information, the customer may easily obtain a comprehensive review of a filed claim without the assistance of an insurance representative.

FIG. 2 illustrates example GUIs 231A and 231B for presenting information relating to claim events. Each of the GUI 231A and the GUI 231B may be presented by way of the display 130 of the device 140 shown in FIG. 1.

The GUI 231A displays a table including rows 202A-210A for presenting information relating to claim events. Each row is associated with a single claim event and includes a claim event date and claim event message. Rows 202A and 206A also include expansion icons 211, each of which may be interacted with by a user to cause the GUI 231A to present additional information on the claim event associated with the row containing the expansion icon 211. The GUI 231A also includes links 213 that may be interacted with by a user to cause the GUI 231A to present additional information. For example, a link 213 may cause the GUI 231A to present information on (i) the claim event associated with the row including the link (e.g., the GUI 231A may present a page or tab including details relating to the claim event); (ii) additional or alternate claim events (e.g., interacting with a link labeled “view all” may cause the GUI 231A to present information on additional claim events); or (iii) claim events of a similar claim event type (e.g., interacting with a link labeled “payment” may cause the GUI 231A to present a table of rows each including information relating to payment claim events).

The GUI 231B presents a table including rows 202B-210B for presenting information on claim events. In particular, GUI 231B includes expanded rows 202B and 208B. Expanded rows 202B and 208B each include a supplemental information area 215. The additional information included in an expanded row may include financial transaction information such as financial transaction identifiers; a status for one or more financial transactions; a financial transaction breakdown (e.g., an itemized list); identifiers for parties of interest; contact information for parties of interest; or messages/remarks from the insurance company, an insurance representative, and/or a third party.

An expansion icon 211 may be interacted with to cause the GUI 231B to contract either of the rows 202B or 208B. For example, interacting with the expansion icon 211 in row 202B may cause the GUI 231B to “contract” row 202B by replacing row 202B with a row similar to row 202A of GUI 231A. Similarly, interacting with the expansion icon 211 in row 202A of GUI 231A may cause the GUI 231A to “expand” row 202A by replacing row 202A with a row similar to row 202B of GUI 231B.

### Example Methods for Automatic Insurance Claim Monitoring

FIG. 3 illustrates an example method 300 for generating a claim event in accordance with the described embodiments. The method 300 may be implemented, in whole or in part, at an OCS such as one of those shown in FIGS. 1, 6, and 7. The method 300 may be saved as a set of instructions, routines, programs, or modules to a memory or storage unit to be retrieved for execution by one or more processors at the OCS. The event generator module 601 shown in FIG. 6 may implement some or all of the blocks 305-325.

The method 300 begins when an OCS receives claim data (block 305). The claim data may be received from a component or module external to the OCS or a component or module within the OCS. The claim data represents information pertaining to a claim filed by a customer of an insurance company. In some instances, the claim data may include information identifying the claim and/or a customer who filed the claim. The claim data may also include one or more messages and/or values for various attributes or variables relating to the insurance claim. In some cases, the claim data may be received from a system or device of a cooperating party (e.g., a rental car company or a car repair company) and may represent a status update relevant to that particular party's role or responsibility (e.g., a rental car status update or a repair status update).

The OCS generates a claim event based on the received claim data (block 310). Broadly speaking, the claim event represents an activity or status change relating to the claim and/or the processing of the claim. For example, the claim event may represent the insurance company completing or beginning a claim processing stage (e.g., inspection, assessment, estimate, or payment). The claim event may represent other activities relating to the claim or insured property as well, such as property rental, subrogation, financial transactions or determinations, assignment of claim representatives for handling the claim, and miscellaneous communication from the insurance company, insurance representatives, or third parties. Consequently, the OCS may generate the claim event in response to the OCS determining that the received claim data represents a new activity or status relating to the claim. By comparison, in some circumstances the received claim data may not represent a new activity or status. For example, the received claim data may represent an update to information previously received by the OCS (e.g., the claim data may relate to a claim event already generated and/or reported by the OCS). In any event, the OCS may generate the claim event in a number of manners. Generally speaking, the claim event is a dataset or a resource that includes or references information representing or describing an activity or status change relating to an insurance claim. For example, the claim event may be a resource such as a file, record, instantiation of an object, a web page, or any other grouping of data elements. In one instance, generating a claim event may include the OCS adding a row to a table (which may also be generated by the OCS), where the row includes information relating to the claim event. The claim event (e.g., the row) may include or reference a claim identifier, an event identifier, a message, a timestamp, links to other resources, and/or various other values for attributes or variables relating to the claim event. In some instances the OCS may associate or include information with the claim event that is considered “supplemental” or “additional.” For example, the expanded rows 202B and 208B shown in FIG. 2 include supplemental information areas 215 that may be generated from supplemental information included in or associated with the claim event.

In addition to generating the claim event, the OCS determines a timestamp associated with the claim event from (i) a timestamp included in the claim data, or (ii) a date and/or time at which the claim data was received or at which time the claim event was generated (block 315). The timestamp may be subsequently used by the OCS or a client device to compare a first claim event to a second claim event, allowing, for example, the first and second claim event to be ordered or allowing someone to determine a time difference between the first and second claim event.

The OCS also generates a claim event message (block 320). The claim event message may be any resource, object, value, file, document, or dataset for communicating information about the claim event. For example, the message may be a simple string of characters in some instances or a graphic file (such as a jpeg or png file) in others. The message may also include an interactive object for linking to a destination resource (e.g., a record, tab, document, webpage, graphic element, etc.) that includes additional information. Whatever the format, the message may describe the activity or status represented by the claim event. The message may also identify a type or category of claim event (e.g., financial event, repair event, etc) and may include a time and/or date (marking, e.g., the time at which the activity represented by the claim event occurred, or the time at which the claim data was received by the OCS). The time and/or date may be based on the timestamp discussed with reference to block 315. In some instances the claim event message may include comments generated by the OCS. The claim event message may also include comments entered by an insurance representative, the customer, or a third party. In some instances, the claim data includes message data that the OCS may rely on to generate the claim event message. The OCS may rely on message templates or default messages stored to memory for generating the claim event message. For example, each claim event message may include text from a default message such as “Event Detected” or “New Event.” The claim data may also include tags or identifiers that allow the OCS to determine a claim event type, where the claim event type may be used to generate a message and/or retrieve a default message or a default message template. For example, each repair status update event message may include the same or similar text retrieved from a default message or message template.

The OCS stores the generated claim event, the generated claim event message, and the determined timestamp to memory (block 325). The claim event message and the timestamp are included in or associated with the claim event. For example, the claim event may be an object or database table including attributes (or rows) having values correlating to the generated claim event message and the determined timestamp. In another example, the claim event may be a resource such as a file or document including addresses (e.g., memory addresses or network address) where the time stamp and claim event message are stored.

The actions referenced in blocks 310, 315, and 320 may occur in any order. For example, the claim event message may be generated before, after, or concurrently with the generation of the claim event and/or the determination of the timestamp. Moreover, the OCS may store data associated with the actions referenced in any one of the blocks 310-320 to memory (block 325) prior to the occurrence of the actions referenced in the other blocks 310-320.

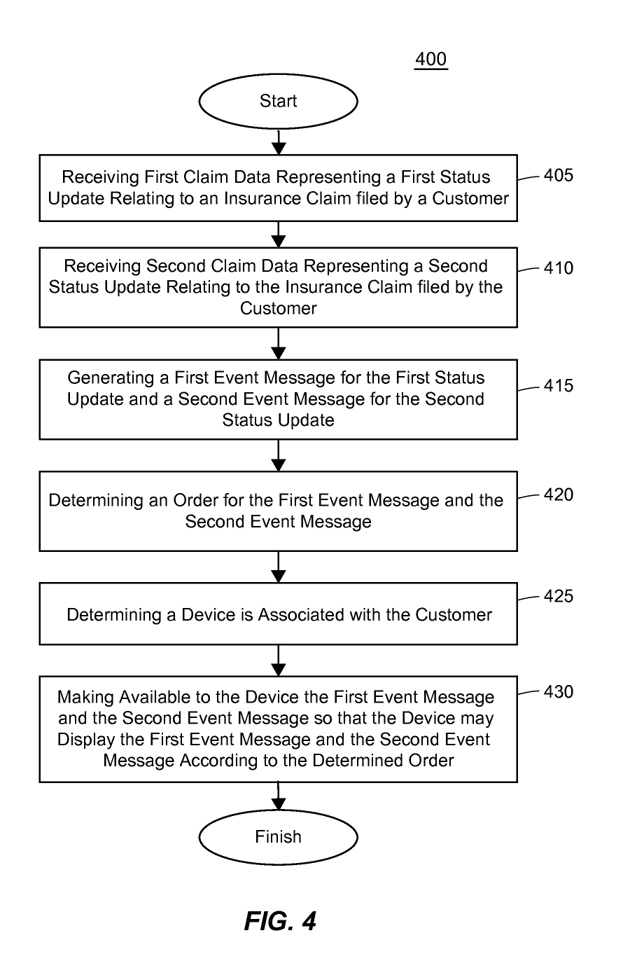

FIG. 4 illustrates an example method 400 for informing a customer of recent claim events in accordance with the described embodiments. The method 400 may be implemented, in whole or in part, at an OCS such as one of those shown in FIGS. 1, 6, and 7. The method 400 may be saved as a set of instructions, routines, programs, or modules to a memory or storage unit to be retrieved for execution by one or more processors at the OCS. In particular, the event generator module 601 and/or the OCS Web Module 603 shown in FIG. 6 may implement some or all of the blocks 405-430.

The method 400 begins when an OCS receives first claim data representing a first activity or status change relating to an insurance claim filed by a customer (block 405) and second claim data representing a second activity or status change relating to the insurance claim filed by the customer (block 410). The claim data may include a header or identifier that identifies the insurance claim and/or the customer who filed the insurance claim. The OCS then generates a first claim event message (corresponding to a first claim event) based on the first claim data and a second claim event message (corresponding to a second claim event) based on the second claim data (block 415).

The OCS determines an order for the first claim event message and the second claim event message (block 420). The determination may be made based on a timestamp such as the timestamp discussed with reference to FIG. 3. In some instances the OCS does not determine an order. In such cases the OCS may make timestamps available, via a network, to a client device so that the client device may display claim events and/or claim event messages according to the timestamps.

The OCS may then determine a device is associated with the customer who filed the insurance claim (block 425) and make the first and second event messages available to the device (block 430) via a network. The OCS may transmit the first and second event messages to the device in response to a request received from the device. Alternatively, the OCS may initiate the communication by transmitting the first and second event messages to the device without receiving a request from the device (i.e., a push communication). In some instances the OCS makes available the first and second messages by way of hosting, at a server, a resource (e.g., a web page) that includes or references the first and second messages. Further, in some cases the device is a mobile device, such as a phone or tablet, and the OCS may make the first and second messages available to a dedicated module or application at the device. The first and second messages may be made available using various protocols, standards, and/or markup languages. For example, the aforementioned resource hosted at a server may be an html or xml document that can be accessed by the client device. As another example, the messages may be delivered and accessed in the form of an email message via one or more protocols such as SMTP, POP3, and/or IMAP. The messages may also be delivered over one or more packet switching networks (e.g., the Internet) or circuit-switching networks (e.g., a telephone network) using, e.g., SMTP and/or SMPP, to be accessed in the form of a text message. In some cases the messages may be delivered and accessed in the form of instant messages. In addition to the first and second claim event messages, all other data associated with or included in either of the first claim event or the second claim event may be made available to the device.

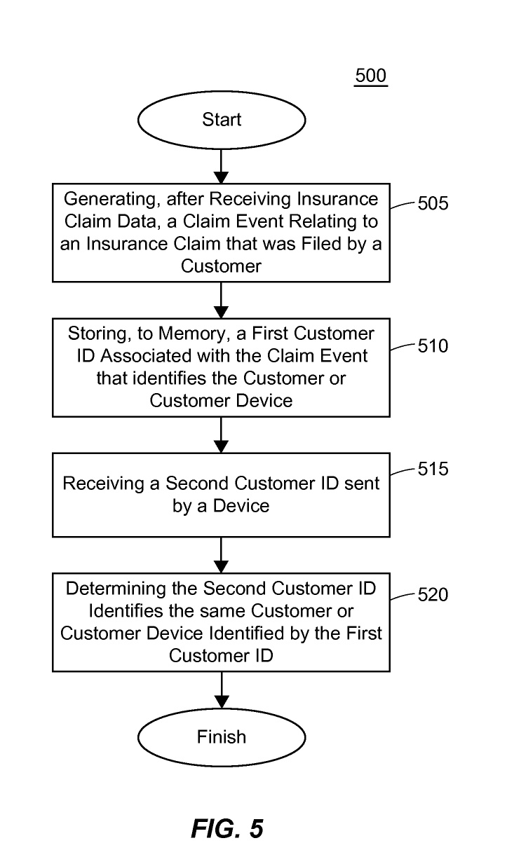

FIG. 5 illustrates an example method 500 for determining a device is associated with a customer in accordance with the described embodiments. The method 500 may be implemented, in whole or in part, at an OCS such as one of those shown in FIGS. 1, 6, and 7. The method 500 may be saved as a set of instructions, routines, programs, or modules to a memory or storage unit to be retrieved for execution by one or more processors at the OCS. In particular, the OCS Web Module 603 shown in FIG. 6 may implement some or all of the blocks 505-520.

The method 500 begins when an OCS generates a claim event relating to an insurance claim filed by a first customer (block 505). The OCS stores, to memory, a first customer identifier (ID) that identifies the first customer or a first device associated with the first customer (block 510). The first customer ID may be any tag, variable value, or key stored to memory that identifies the first customer or first client device. For example, the first customer ID may be the customer's name, e-mail, phone number, a random group of digits, a MAC address, an network address, or any other identifier. The first customer ID may be received or generated at the OCS when information pertaining to the claim event or first customer is initially received or generated. For example, the first customer ID may be received when the customer's information is first entered to the OCS (e.g., at or proximate to the time when the first customer purchased her policy). The customer ID may be received via user input (e.g., from an insurance representative or the customer) at a user interface at the OCS or at a device in communication with the OCS. The customer ID may also be generated based on the user input. For example, a user may enter the customer's name and the OCS may generate the customer ID based on the customer's name. Moreover, the OCS may automatically generate a customer ID, absent user input, upon receiving initial claim data pertaining to a new claim (e.g., a claim for which the OCS has no record or information) or upon generating an initial claim event relating to the new claim (e.g., a claim for which the OCS may have information but for which no claim event has yet been generated).

The OCS then receives, via a network, a second customer ID (block 515) that was sent by the first device. The OCS may then determine that the second customer ID identifies the same customer or client device identified by the first customer ID (i.e., the first customer or the first client device) (block 520). The OCS may make this determination by comparing the second customer ID to the first customer ID to determine that the first and second customer IDs match. The OCS may perform a function on both the first customer ID and the second customer ID to determine the first and second customer ID identify the first customer. For example, first customer ID may be a name such as “jsmith” and the second customer ID may be an email address such as “jsmith@email.com.” A hash function may be used by the OCS to determine that each ID maps to a single index associated with the first customer.

### Example Systems for Automatic Insurance Claim Monitoring

FIG. 6 illustrates a block diagram of an example automated insurance claim monitoring system 600. The automated insurance claim monitoring system 600 includes a device 640 (similar to the device 140 illustrated in FIG. 1) communicatively connected to an OCS 620 by way of a network 610.

The OCS 620 includes a server 630 (which may be a computer such as the computer 800 shown in FIG. 8) and an events database 622. The events database 622 may be stored at one or more memory units, accessible by the server 630, in the OCS 620.

The server 630 includes a processor 632 communicatively connected to both a memory 634 and a network interface 636. The processor 632 may be any processor or group of processors (which may include, e.g., a CPU and/or GPU) configured to fetch and execute instructions stored to memory 634. In particular, the processor 632 may perform some or all of the methods or operations described herein. In some instances, performance of certain parts of the methods or operations described herein may be distributed among one or more processors residing across a plurality of machines. The one or more processors may share a similar geographic location in some instances (e.g., a server farm), or may be distributed across a number of geographically distinct areas. Moreover, the one or more processors may operate to support performance of relevant operations in a “cloud computing” environment. For example, at least some of the operations may be performed by a group of computers or by the previously described plurality of machines, wherein the operations are accessible via a network (accessible by, e.g., the network interface 636).

The memory 634 can include volatile (e.g., RAM) and/or non-volatile memory (e.g., a harddisk). The memory 634 may be any device or group of devices that stores instructions making up one or more programs or modules, as well as data operated on and/or produced by such programs or modules. In particular, the memory 634 stores instructions making up (i) the event generator module 631 and (ii) the web module 633. In operation, the processor 632 fetches and executes the instructions. In various implementations, the event generator module 631 and the web module 633 may include compiled instructions, instructions that are interpreted at runtime, etc.

The server 630 uses the network interface 636 to communicate with systems external to the server 630 (e.g., by way of the network 610). In particular, the processor 632 may communicate with the network interface 636 to cause the network interface 636 to transmit or receive data. The network interface 636 may include one or more antennas for wireless communication, one or more ports for wired communication, a connection to a modem, a connection to a router, or some combination thereof.

In operation, the server 630 receives claim data at the network interface 636. The claim data may be received from a device or system external to the OCS 620, or may be received from a device or system in the OCS 620. In some instances, the claim data may be generated by the processor 632. Any device or module that makes claim data available to the OCS 620 is considered a “claim data publisher.” As an example, a computer system utilized by a car repair facility may be a claim data publisher, where the computer system is used to transmit car repair updates to the OCS 620. In some cases the claim data may include an identifier unique to an activity or status update (e.g., a first car repair status update may be distinguishable from a second car repair status update) and may indicate a type of activity or status update to which the claim data relates (e.g., car repair status update vs payment update).

Once the claim data has been received or generated at the server 630, the event generator module 631 causes the processor 632 to generate a claim event and add the claim event to the events database 624. The claim event may be stored at the memory 634 or any other memory unit in the OCS 620. The events database 624 may include additional claim events, and the claim events may be ordered or associated with a timestamp that can be used to order the claim events. In some cases, rather than generating a new claim event, the OCS 620 may update a claim event already existing in the events database 624. For example, the OCS 620 may update an already existing claim event when the received claim data includes an identifier equivalent to an identifier included in previously received claim data.

The web module 633 causes the processor 632 to make available, by way of the network 610, one or more of the claim events stored at the events database 624. In particular, the processor 632 may retrieve a claim event from the events database 624 and instruct the network interface 636 to transmit the claim event via the network 610 to the device 640. For example, an antenna at the network interface 636 may wirelessly transmit data representing the claim event.

The client device 640 includes a processor 642 (similar to the previously described processor 632) communicatively connected (e.g., by way of a system bus) to (i) a memory 644 (similar to the previously described memory 634), (ii) a network interface 646 (similar to the previously described network interface 636), and (iii) a user interface 648 (“UI 648”). The UI 648 may include a display 650. Generally speaking, the UI 628 may also include or connect to any suitable input or output devices, such as a touchscreen, a keyboard, a mouse and/or speakers. In some embodiments, some or all of the UI 628 may be remotely located relative to the other components of the device 640 and the UI 628 may communicate with the components of the computer system 620 via the network interface 626. The memory 644 stores an OCS user module 641. The network interface 646 may transmit and receive data to/from the OCS 620 (and more particularly, the server 630) by way of the network 610.

In operation, the OCS user module 641 causes the device 640 to display information based on claim events received from the OCS 620. In particular, the network interface 646 may receive one or more claim events from the server 630 of the OCS 620. The OCS user module 641 may cause the processor 642 to store the claim events at the memory 644. The OCS user module 641 causes the display 650 to generate a GUI based on the received claim events. More particularly, the OCS user module 641 may cause the processor 642 to identify or generate claim event messages from the received claim events and then generate a GUI including the claim event messages. In some instances, the OCS user module 641 may be a dedicated application or program designed to interact with the OCS 620. Depending on the implementation, the OCS user module 641 may be compatible with various hardware architectures and/or operating systems (mobile or otherwise). For example, in some instances the OCS user module 641 may be designed for a mobile operating system and the device 640 may be a mobile device such as a phone or tablet. In some instances the OCS user module 641 may be a browser that receives the claim event in response to being navigated to a network address corresponding to the claim event, or a resource referencing or including the claim event (where the claim event and/or resource are hosted at the server 630).

FIG. 7 illustrates a data flow diagram of an example distributed OCS 700. The OCS 700 includes a host 701 communicatively connected to a subscriber 702. Both the host 701 and the subscriber 702 may be devices similar to the server 630 illustrated in FIG. 6. In general, the host 701 makes claim events available to the subscriber 702. The subscriber 702 receives the claim events and makes the claim events available to appropriate client devices (e.g., device 140).

The host 701 includes an event generator module 731 and an event processor module 715 (“EP 715”) stored to memory, each of which may be executed by one or more processors at the host 701. The host 701 further includes an event table 710 and an EP Queue 720, each of which are organized collections of data stored to memory. More particularly, the event table 710 and EP queue 720 each include ordered collections of claim events or references to claim events (e.g., pointers). While the EP queue 720 is shown as a queue, in some implementations the EP queue 720 may be a stack or any other data collection to which claim events may be added and removed in an organized manner.

The subscriber 702 includes an EP subscriber module 725 and a web module 733 that may each be executed by one or more processors at the subscriber 702. The subscriber 702 also includes a first claim events table 740 and a second claim events table 745, each of which are data collections, stored to memory, for organizing claim event data. More particularly, the first claim events table 740 includes claim events relating to a first claim and the second claim events table 745 includes claim events relating to a second claim. In some instances the subscriber 702 includes additional tables relating to additional claims.

In operation, the event generator module 731, when executed at a processor of the host 701, causes the processor to generate a claim event based on claim data received or generated at the host 701. The event generator module 731 then causes a processor to add the claim event to the claim event table 710. The claim event table 710 may include multiple events generated by the event generator 731. In some cases, all events generated by the event generator 731 are added to the event table 710.

The EP 715, when executed at a processor of the host 701, causes the processor to add one or more claim events from the claim event table 710 to the EP queue 720. In some instances, the EP 715 may add claim events to the EP queue 720 as the claim events are added to the claim event table 710. The EP 715 may add claim events to the EP queue 720 so that the claim events in the EP queue 720 are ordered according to a timestamp associated with each of the claim events. In any event, the EP queue 720 may include claim events ordered so that when a claim event is removed from the EP queue 720, the most recent claim event is removed.

The EP subscriber 725 causes a processor of the subscriber 702 to transmit a request signal to the host 701. Upon receiving the request signal at the host 701, the EP 715 causes the host 701 to remove a claim event from the EP Queue 720 and transmit data representing the claim event to the subscriber 702. In some instances the host 701 removes a claim event from the EP Queue 720 and transmits data representing the claim event to the subscriber 702 without receiving a request signal from the subscriber 702.

After receiving data representing a claim event at the subscriber 702, the EP subscriber module 725 causes a processor of the subscriber 702 to add a claim event to the first claim events table 740 or to the second claim events table 745, depending on a claim identifier included in the claim event. The first claim events table 740 and the second claim events table 745 include ordered claim events. For example, the first claim events table 740 may include events ordered according to date/time of creation or according to a timestamp included in each of the claim events. In some instances a received claim event may replace a claim event already included in either the first claim events table 740 or the second claim events table 745.

The web module 733 makes available one or more events from the first claim events table 740 to a device associated with a customer who filed the first claim. The web module 733 may also make available one or more claim events from the second claim events table 745 to a device associated with a customer who filed the second claim. In some instances, the subscriber 702 may include multiple web modules 733. For example, each web module 733 may be associated to a particular events table. Methods for making claim events available to a client device are discussed with reference to FIGS. 4 and 6.

In some embodiments of the OCS 700, the OCS 700 may include additional subscribers 702. The EP subscriber module 725 of each subscriber 702 may cause each subscriber 702 to receive claim events from the host 702 relating to a particular claim or group of claims. For example, a second subscriber 702 may include a third claim events table and a fourth claim events table and the second subscriber 702 may receive claim events from the host 701 relating to a third claim and a fourth claim.

### Additional Considerations

Throughout this specification, plural instances may implement modules, components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain implementations are described herein as including logic or a number of components, modules, or mechanisms. Modules may constitute either software modules (e.g., code implemented on a tangible, non-transitory machine-readable medium such as RAM, ROM, flash memory of a computer, hard disk drive, optical disk drive, tape drive, etc.) or hardware modules (e.g., an integrated circuit, an application-specific integrated circuit (ASIC), a field programmable logic array (FPLA)/field-programmable gate array (FPGA), etc.). A hardware module is a tangible unit capable of performing certain operations and may be configured or arranged in a certain manner. In example implementations, one or more computer systems (e.g., a standalone, client, server, or host computer system) or one or more hardware modules of a computer system (e.g., a processor or a group of processors) may be configured by software (e.g., an application or application portion) as a hardware module that operates to perform certain operations as described herein.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

The use of the terms “a” and “an” and “the” and similar referents in the context of describing the invention is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to illuminate better the feature and does not pose a limitation on the scope of the disclosure unless otherwise claimed. No language in the specification should be construed as indicating any non-claimed element as essential to the disclosure.

While the foregoing description of the present system has been shown and described in connection with various particular embodiments and applications thereof, it has been presented for purposes of illustration and description and is not intended to be exhaustive or to limit the electronic system to the particular embodiments and applications disclosed. It will be apparent to those having ordinary skill in the art that a number of changes, modifications, variations, or alterations to the system as described herein may be made, none of which depart from the spirit or scope of the present disclosure. The particular embodiments and applications were chosen and described to provide the best illustration of the principles of the system and its practical application to thereby enable one of ordinary skill in the art to utilize the system in various embodiments and with various modifications as are suited to the particular use contemplated. All such changes, modifications, variations, and alterations should therefore be seen as being within the scope of the present disclosure.

1. A computer implemented method for automatically providing timely status updates about an insurance claim, the method comprising:
causing one or more processors of a server to store, to a memory, a first claim event relating to a first insurance claim filed by a first user, the first claim event being a dataset including a first plurality of attribute values, the first plurality of attribute values including (i) a first claim identifier (ii) a first event identifier, (iii) a first timestamp, and (iv) a first event message regarding a status update for the first insurance claim;
receiving claim data at a network interface of the server;
causing one or more processors at the server to determine, from the received claim data, a second plurality of attribute values, the second plurality of attribute values including:
a second claim identifier,
a second event identifier,
a second timestamp, and
a second event message;
causing the one or more processors at the server to determine that the second claim identifier identifies the first insurance claim;
causing the one or more processors at the server to determine, by comparing the second event identifier to the first event identifier, whether the second event identifier is associated with the first claim event;
when the second event identifier is associated with the first claim event, causing the one or more processors at the server to associate the second event message with the first claim event; and
when the second event identifier is not associated with the first claim event, causing the one or more processors at the server to:
(i) generate a second claim event, the second claim event being a dataset including at least the second timestamp and the second event message,
(ii) determine a chronological order based on the first timestamp associated with the first claim event and the second timestamp associated with the second claim event, and
(iii) make available, to a device, the first event message and the second event message so that the device may display the first event message and the second event message according to the determined chronological order.

2. The computer implemented method of claim 1, wherein the first claim event further includes a first customer identifier identifying (i) the first customer or (ii) a verified device associated with the first customer, and wherein the method further comprises:
receiving a second customer identifier sent by the device; and
comparing the second customer identifier to the first customer identifier to verify that the second customer identifier either (i) identifies the first customer, or (ii) identifies the verified device.

3. The computer implemented method of claim 1, wherein causing the one or more processors to make available, to a device, the first event message and the second event message so that the device may display the first event message and the second event message according to the determined chronological order, comprises:
transmitting the first event message and the second event message to the device via a telephone network, wherein the device is a telephone.

4. The computer implemented method of claim 1, wherein causing the one or more processors to make available, to a device, the first event message and the second event message so that the device may display the first event message and the second event message according to the determined chronological order, comprises:
hosting, at the server, a resource accessible via a network address, wherein the server transmits the first event message and the second event message to the device when the device accesses the resource at the network address.

5. The computer implemented method of claim 1, wherein:
the first claim event is a first row in a database table, wherein the first row includes a field for each of the first plurality of attribute values; and
the second claim event is a second row in the database table, wherein the second row includes a field for each of the second plurality of attribute values.

6. The computer implemented method of claim 1, wherein:
the first claim event is a first row in a database table, wherein the first row includes a field for each of the first plurality of attribute values; and
the second claim event is a second row in the database table, wherein the second row includes a field for each of the second plurality of attribute values.

7. The computer implemented method of claim 6, wherein causing the one or more processors at the server to generate a second claim event includes:
storing the second claim event to a queue;
retrieving the second claim event from the queue; and
storing the second claim event to the database table, where the database table includes claim events for the first insurance claim.

8. The computer implemented method of claim 1, wherein causing the one or more processors to make available, to a device, the first event message and the second event message so that the device may display the first event message and the second event message according to the determined chronological order, comprises:
transmitting, to the device, at least one of: (i) a document including the first event message and the second event message, (ii) an email-message including the first event message and the second event message, (iii) a text-message including the first event message and the second event message, or (iv) an instant message including the first event message and the second event message.

9. An online claim system for automatically providing timely status updates about an insurance claim, the online claim system comprising:
(a) one or more memories storing a first claim event relating to a first insurance claim filed by a first user, the first claim event being a dataset including a first plurality of attribute values, the first plurality of attribute values including (i) a first claim identifier identifying the first insurance claim, (ii) a first event identifier identifying the first claim event, (iii) a first timestamp identifying a first time, and (iv) a first event message regarding a status update for the first insurance claim;
(b) a computer server coupled to the one or more memories, the computer server configured to:
(i) receive from a publisher device claim data that includes a second plurality of attribute values, the second plurality of attribute values including:
a second claim identifier,
a second event identifier,
a second timestamp, and
a second event message;
(ii) automatically determine that the second claim identifier identifies the first insurance claim identified by the first claim identifier stored to the one or more memories;
(iii) automatically determine whether the second event identifier identifies (1) the first claim event identified by the first event identifier or (2) a second claim event; and
(iv) transmit to a client device the first event message stored to the one or more memories and the second event message received from the publisher device when the second event identifier identifies the second claim event, wherein the first event message and the second event message are transmitted to the client device so that the client device can display the first event message and the second event message according to a chronological order determined from the first timestamp associated with the first claim event and the second timestamp associated with the second claim event.

10. The online claim system of claim 9, wherein the first claim event further includes a first customer identifier identifying (i) the first customer or (ii) a verified device associated with the first customer, and wherein the computer server is further configured to:
receive a second customer identifier sent by the client device; and
compare the second customer identifier to the first customer identifier to verify that the second customer identifier either (i) identifies the first customer, or (ii) identifies the verified device.

11. The online claim system of claim 9, wherein the computer server is further configured to:
transmit the first event message and the second event message to the client device via a telephone network, wherein the device is a telephone.

12. The online claim system of claim 9, wherein the computer server is further configured to:
host a resource accessible via a network address, wherein the computer server transmits the first event message and the second event message to the client device when the device accesses the resource at the network address.

13. The online claim system of claim 9, wherein:
the first claim event is a first row in a database table, wherein the first row includes a field for each of the first plurality of attribute values; and
the second claim event is a second row in the database table, wherein the second row includes a field for each of the second plurality of attribute values.

14. The online claim system of claim 13, wherein the computer server is further configured to:
store the second claim event to a queue;
retrieve the second claim event from the queue; and
store the second claim event to the database table, where the database table includes claim events for the first insurance claim.

15. The online claim system of claim 13, wherein the computer server is further configured to:
transmit, to the client device, at least one of: (i) a document including the first event message and the second event message, (ii) an email-message including the first event message and the second event message, (iii) a text-message including the first event message and the second event message, or (iv) an instant message including the first event message and the second event message.

16. A tangible computer-readable medium including non-transitory computer readable instructions that, when executed at one or more processors of an online claim system, cause the one or more processors to:
store, to memory, a first claim event relating to a first insurance claim filed by a first user, the first claim event being a dataset including a first plurality of attribute values, the first plurality of attribute values including (i) a first claim identifier (ii) a first event identifier, (iii) a first timestamp, and (iv) a first event message regarding a status update for the first insurance claim;
determine, from the received claim data, a second plurality of attribute values, the second plurality of attribute values including:
a second claim identifier,
a second event identifier,
a second timestamp, and
a second event message;
determine that the second claim identifier identifies the first insurance claim;
determine, by comparing the second event identifier to the first event identifier, whether the second event identifier is associated with the first claim event;
when the second event identifier is associated with the first claim event, associate the second event message with the first claim event; and
when the second event identifier is not associated with the first claim event:
(i) generate a second claim event, the second claim event being a dataset including at least the second timestamp and the second event message,
(ii) determine a chronological order based on the first timestamp associated with the first claim event and the second timestamp associated with the second claim event, and
(iii) make available, to a device, the first event message and the second event message so that the device may display the first event message and the second event message according to the determined chronological order.

17. The tangible computer-readable medium of claim 16, wherein the first claim event further includes a first customer identifier identifying (i) the first customer or (ii) a verified device associated with the first customer, and wherein the instructions, when executed, further cause the one or more processors to:
compare a second customer identifier, received from the device, to the first customer identifier to verify that the second customer identifier either (i) identifies the first customer, or (ii) identifies the verified device.

18. The tangible computer-readable medium of claim 16, wherein the instructions that cause the one or more processors to make available, to a device, the first event message and the second event message so that the device may display the first event message and the second event message according to the determined chronological order, comprise instructions that cause the one or more processors to:
transmit the first event message and the second event message to the device via a telephone network, wherein the device is a telephone.

19. The tangible computer-readable medium of claim 16, wherein the instructions that cause the one or more processors to make available, to a device, the first event message and the second event message so that the device may display the first event message and the second event message according to the determined chronological order, comprise instructions that cause the one or more processors to:
host, at a server, a resource accessible via a network address, wherein the instructions cause the server to transmit the first event message and the second event message to the device when the device accesses the resource at the network address.

20. The tangible computer-readable medium of claim 16, wherein:
the first claim event is a first row in a database table, wherein the first row includes a field for each of the first plurality of attribute values; and
the second claim event is a second row in the database table, wherein the second row includes a field for each of the second plurality of attribute values.

21. The tangible computer-readable medium of claim 16, wherein the instructions that cause the one or more processors to generate a second claim event further cause the one or more processors to:
store the second claim event to a queue;
retrieve the second claim event from the queue; and
store the second claim event to the database table, where the database table includes claim events for the first insurance claim.

22. The tangible computer-readable medium of claim 16, wherein the instructions that cause the one or more processors to make available, to a device, the first event message and the second event message so that the device may display the first event message and the second event message according to the determined chronological order, further cause the one or more processors to:
transmit, to the device, at least one of: (i) a document including the first event message and the second event message, (ii) an email-message including the first event message and the second event message, (iii) a text-message including the first event message and the second event message, or (iv) an instant message including the first event message and the second event message.
